(19) United States
(12) Patent Application Publication
(10) Pub. No.: US 2015/0368440 A1
(43) Pub. Date: Dec. 24, 2015

(54) COMPOSITION COMPRISING MODIFIED SILICA AND SILICONE RUBBER COMPRISING THIS COMPOSITION

(71) Applicants: Mario SCHOLZ, Gründau (DE); Jürgen MEYER, Stockstadt (DE)

(72) Inventors: Mario SCHOLZ, Gruendau (DE); Juergen MEYER, Stockstadt (DE)

(73) Assignee: EVONIK DEGUSSA GMBH, Essen (DE)

(21) Appl. No.: 14/766,039

(22) PCT Filed: May 23, 2013
(86) PCT No.: PCT/EP2013/060599

§ 371 Date: Aug. 5, 2015

(30) Foreign Application Priority Data
Mar. 19, 2013 (EP) 13159993.8

(51) Int. Cl. C08K 9/06; C09C 1/30; C07F 7/18

(52) U.S. Cl. CPC C08K 9/06; C07F 7/188; C09C 1/3081; C01P 2006/12; C01P 2002/86; C01P 2002/82

(57) ABSTRACT

Process for producing a composition comprising at least one surface-modified silica, where
a) a hydrophilic silica
b) is first brought into contact with from 5 to 40 parts by weight per 100 parts by weight of hydrophilic silica of an α,ω-hydroxy-terminated oligodimethylsiloxane with an average molar mass of from 166 to 800 g/mol, where the contact takes place at temperatures of from −10° C. to 50° C., and
c) then allowing the resultant reaction mixture to stand for at least 3 days at temperatures of from −10° C. to 50° C.

### CROSS-REFERENCE TO RELATED APPLICATIONS

This application is a U.S. national-stage filing of PCT/EP2013/060599, filed May 23, 2013 which claims priority to EP 13159993.8, filed Mar. 19, 2013.

### BACKGROUND OF THE INVENTION

1. Field of the Invention

The invention relates to a process in which a hydrophilic silica is surface-modified with α,ω-hydroxy-terminated oligodimethylsiloxanes. The invention further relates to the resultant modified silica and to a silicone rubber which comprises the same.

2. Description of the Related Art

There are numerous known processes in which the surface of silicas is modified with organic silicon compounds.

DE-A-4419234 discloses a process in which a fluidized silica is mixed vigorously at a temperature of from 0 to 350° C. with an organodimethylsiloxane which has dimethylhydroxysiloxy units as terminal group and an average number of from 1 to 200 dimethylsiloxy units. The mixing procedure takes place during a residence time of from 1 second to 24 hours. A post-treatment then takes place at a temperature of from 0 to 400° C. over a period of from 1 minute to 48 hours.

EP-A-1302444 discloses a process for producing a silylated silica in which a silica takes place in a single vessel with an organodimethylsiloxane which can have dimethylhydroxysiloxy units as terminal group. The process comprises the steps of the loading of the silica with silylating agent and of the reaction of the silica with the silylating agent, and comprises the purification process to remove silylating agent and ancillary reaction products from the silica. Gravity is preferably used to transport the silica from the first to the third step. The coating process takes place at from −30 to 250° C. with a loading time of from 1 minute to 24 hours. The reaction takes place at from 40 to 400° C. and with a reaction time of from 5 minutes to 48 hours. The purification process to remove ancillary reaction products takes place at a purification temperature of from 20 to 350° C.

EP-A-1304361 discloses a process for producing a silylated silica in which a silica is reacted with an organodimethylsiloxane which has dimethylhydroxysiloxy units as terminal group. The reaction can be achieved in one step or in 2 or 3 sequential steps. This means that a loading process, corresponding to physisorption of the organodimethylsiloxane, can be implemented upstream of the reaction, and also that a purification step can be implemented downstream of the reaction.

Preference is given to 3 sequential steps, namely loading, reaction and purification. In order to avoid oxidation of the silylated silica, the entire reaction, comprising the steps of loading, reaction and purification, has to be carried out in an atmosphere with less than 2.5% of oxygen by volume.

The reaction temperatures are preferably from 200 to 400° C., and the reaction times are preferably from 1 min to 24 h. If there is a previous loading step, the loading temperature is preferably from −30 to 350° C. If there is a subsequent purification step, the purification temperature is preferably from 100 to 400° C.

WO2009/077437 discloses a process in which a silica is reacted under oxidizing conditions with an organodimethylsiloxane which has dimethylhydroxysiloxy units as terminal group. The process comprises the coating of the silica with the organodimethylsiloxane, the reaction and the purification of the silica to remove excess applied compounds and ancillary products. Partial oxidation of the silica is intended. The coating process preferably takes place at temperatures below 400° C., preferably from −30 to 250° C. The residence time is preferably from 1 minute to 24 hours. The reaction preferably takes place at temperatures below 400° C., particularly preferably at from 150 to 350° C. The purification process preferably takes place at a temperature of from 20 to 400° C. The silicas disclosed in WO2009/077437 have a surface modified with T groups and with D groups.

The expression T group means a monoalkyltrisiloxy group R—Si(O—)₃. T₁ is R—Si(OR′)₂-O—Si, T₂ is R—Si(OR′)(—O—Si)₂ and T₃ is R—Si(—O—Si)₃, where R can be a Si—C-bonded alkyl moiety and R′ can be an alkyl group or hydrogen atom.

The expression D group means a dialkyldisiloxy group (R—)₂Si(O—)₂. D₁ is Si—O—Si(R₂)OH, D2 is Si—O—SiR₂—OR′, D3 is (Si—O)₂SiR₂ and D4 is Si—O—SiR₂—O—SiR₂—O.

A Q₂ group is (HO)₂Si—(O—Si)₂, a Q₃ group is (HO)Si—(O—Si)₃and a Q₄ group is Si—(O—Si)₄.

The surface-modified silicas mentioned in the prior art are intended to be useful as reinforcing filler in silicone rubber. The suitability of this type of silica depends in essence on whether it can be incorporated quickly into the uncrosslinked silicone composition and whether acceptable physical properties of the crosslinked silicone composition can be achieved. It is desirable to incorporate the silica by what is known as the “cold mixing” process, in which the silica is incorporated at room temperature into the uncrosslinked silicone rubber. The surface-modification process is usually carried out in situ. This means that a surface-modifier is mixed together with a silicone rubber and with a hydrophilic silica. The hydrophilic silica thus reacts with the surface modifier during incorporation into the silicone rubber. The person skilled in the art is aware that use of short-chain hydroxysiloxanes gives good-quality silica-containing silicone rubbers only if the water formed in the reaction of the hydroxy groups of the silica surface with the hydroxysiloxane is removed.

### BRIEF SUMMARY OF THE INVENTION

The technical object of the present invention therefore consisted in providing a silica in a form which can advantageously be used in silicone rubbers.

The technical object further consisted in providing a process which leads to a silica-containing product which can be used advantageously in silicone rubbers.

### BRIEF DESCRIPTION OF THE DRAWING

FIG. 1 shows a typical curve for a composition according to the invention, characterized as square, in comparison with a polydimethylsiloxane-hydrophobized silica, namely AEROSIL® R202, Evonik Industries, characterized as circle. The x-axis here is methanol content in % by volume, and the y-axis is sediment volume in %.

### DETAILED DESCRIPTION OF THE INVENTION

The invention provides a process for producing a composition comprising at least one surface-modified silica, where
a) a hydrophilic silica
b) is first brought into contact with from 5 to 40 parts by weight, preferably from 10 to 20 parts by weight, per 100 parts by weight of hydrophilic silica of an α,ω-hydroxy-terminated oligodimethylsiloxane with an average molar mass of from 166 to 800 g/mol, preferably from 300 to 500 g/mol, where the contact takes place at temperatures of from −10° C. to 50° C., and
c) then allowing the resultant reaction mixture to stand for at least 3 days, preferably from 1 week to 2 years, at temperatures of from −10° C. to 50° C.

The composition is a pulverulent composition.

A feature of the process according to the invention is that there are no measures provided for removing liquid or gaseous reaction products, such as water. It is assumed that the hydroxy groups of the α,ω-hydroxy-terminated oligodimethylsiloxane react at least to some extent with the hydroxy groups on the surface of the silica to form water. It is moreover assumed that some of the α,ω-hydroxy-terminated oligodimethylsiloxane has been bound adsorptively to the silica.

During the period provided in step c) the reaction mixture can be in the silo, in a FIBC (flexible intermediate bulk container) or in a sack.

Step c) of the process according to the invention can be followed by a compaction step. This can by way of example use rolls.

Another characterizing feature of the process is that the temperature range mentioned in steps b) and c) is very low in comparison with the prior art. Steps b) and c) of the process according to the invention are usually carried out at room temperature, i.e. at from 15 to 25° C.

The contact according to step b) is advantageously achieved through atomization by means of one-fluid or multi-fluid nozzles or by means of ultrasound atomization of the α,ω-hydroxy-terminated oligodimethylsiloxane onto the fluidized silica.

In one embodiment of the process, the contact is achieved under inert gas. The expression inert gas is intended to mean that the proportion of oxygen is not more than 5% by volume, preferably not more than 2.5% by volume. However, it is also possible to achieve the contact under conditions with more than 5% by volume, for example in air.

In another embodiment of the process, the selected atmosphere in which the reaction mixture is allowed to stand for at least 3 days according to step c) is an atmosphere having more than 5% by volume oxygen content. Preferred atmosphere is air.

In a preferred method for the process, the contact is achieved under inert gas, and the atmosphere in which the reaction mixture is allowed to stand for at least 3 days according to step c) is air.

The silica used in the process is a hydrophilic silica. It is possible to use either fumed silicas or precipitated silicas.

Better results are achieved with fumed silicas. The expression fumed silicas means silicas obtained through flame hydrolysis or flame oxidation of silicon halides, such as SiCl₄. The surface of the silica bears hydroxy groups in the form of Si—OH. In the case of the fumed, hydrophilic silicas the silanol group density determined by using the reaction of the silicon dioxide powder with lithium aluminium hydride by the method of J. Mathias and G. Wannemacher (Journal of Colloid and Interface Science 125, 1988, 61) is generally from 1.8 to 2.5. The type of fumed, hydrophilic silica that can be used in the process according to the invention mainly takes the form of three-dimensional aggregates of primary particles. While the diameter of the primary particles is generally from 5 to 50 nm, the aggregate diameter can be up to several micrometres, usually from 0.5 to 5 μm.

The BET surface area of the fumed, hydrophilic silica used in the process of the present invention is preferably from 150 to 400 m²/g, particularly preferably from 180 to 350 m²/g, very particularly preferably from 220 to 280 m²/g. The tamped density of the silicas is preferably from 20 to 150 g/l in accordance with DIN EN ISO 787/11.

Typical products are by way of example AEROSIL® 150, AEROSIL® 200, AEROSIL® 300 or AEROSIL® 380, all from Evonik Industries.

The average molar mass of the α,ω-hydroxy-terminated oligodimethylsiloxane used in the process according to the invention is from 166 to 800 g/mol, preferably from 300 to 500 g/mol. The α,ω-hydroxy-terminated oligodimethylsiloxane is generally a mixture of two or more compounds. Tetramethyl-1,3-disiloxanediol can also be used as sole compound. However, preference is given to an α,ω-hydroxy-terminated oligodimethylsiloxane with an average molar mass of from 200 to 800 g/mol, and very particular preference is given to one with an average molar mass of from 300 to 500 g/mol. The dynamic viscosity is preferably less than 50 mPas, particularly preferably from 15 to 45 mPas, and very particularly preferably from 20 to 40 mPas, in each case at a temperature of 20° C.

The invention further provides a composition obtainable according to the process according to the invention.

In one particular embodiment of the invention, the composition has the following features:
a) according to TEM a structure in the form of aggregated primary particles with a BET surface area of from 150 to 250 m²/g,
b) from 91.5 to 96.0% by weight content of SiO₂ and from 2.5 to 4.0% by weight content of C,
c) a D/Q ratio of from 25:75 to 40:60 in the HPDEC ²⁹Si NMR spectrum, where D is the area of the signals of the D group at from −90 to −120 ppm and Q is the area of the signals of the Q group at from −10 to −30 ppm,
d) a E₃₆₆₀/E₁₈₇₀ quotient ≧1.3, preferably from 1.4 to 2.0, particularly preferably from 1.5 to 1.8, in the IR spectrum, where the E₃₅₀₀/E₁₈₇₀ quotient is 2.0, preferably from 2.0 to 4.0, particularly preferably from 2.5 to 3.5, where
   E₃₆₆₀ is the extinction coefficient of the vibration band at 3660 cm⁻¹,
   E₃₅₀₀ is the extinction coefficient of the vibration band at 3500 cm⁻¹ and
   E₁₈₇₀ is the extinction coefficient of the vibration band at 1870 cm⁻¹.

The composition exhibits a particularly short time for incorporation into silicone rubber. It is less than 60 minutes, preferably from 30 to 50 minutes. The time for incorporation is determined by mixing 100 parts by weight of Rhodorsil® Gomme 751, Bluestar Silicones, CAS No. 68083-18-1, as uncrosslinked silicone rubber, and 40 parts of the composition in a LUK-2,5 laboratory kneader from Werner and Pfleiderer at room temperature, which is from 20 to 25° C. The composition is added in three portions here, namely amounting to 60% by weight, 25% by weight and 15% by weight of the total amount, and the next addition takes place when the composition appears visually to have been absorbed within the uncrosslinked silicone rubber.

TEM is transmission electron microscopy. BET surface area can be determined in accordance with DIN 66131 and DIN 66132.

HPDEC (high power decoupling) ²⁹Si NMR spectroscopy is a standard method for determining silicon content in solids.

No T groups can be detected in the composition according to the invention. The meaning of D group, Q group and T group has already been mentioned in the description. An Avance 400 FT-NMR spectrometer is used.

The IR spectra are obtained on powder layers by using a Bruker IFS 85 FT-IR spectrometer. The sample for determination is dusted onto a monocrystalline NaCl window. The measurement parameters are as follows: resolution: 2 cm⁻¹, measurement interval: from 4500 cm⁻¹ to 100 cm⁻¹, apodization function: triangular, number of scans 128. Extinction coefficient is determined as follows: To establish the base line, tangents to the base line are drawn in the region from about 3800 cm⁻¹ to about 2800 cm⁻¹, and also in the region from about 2100 cm⁻¹ to 1750 cm⁻¹. From the maximum of the relevant bands at 3660, 3500 and 1870 cm⁻¹ a perpendicular is drawn to the base line, and the respective heights from the maximum to the base line are measured in mm. It is assumed that the vibration band at 3660 cm⁻¹ derives from a bridged SiOH vibration and that the vibration band at 3500 cm⁻¹ derives from an OH vibration (H₂O+SiOH). The extinction coefficient of these bands is standardized by dividing by the extinction coefficient for the band of the SiO combination vibration.

The quotient D/Q determined by means of HPDEC ²⁹Si NMR spectroscopy, and the standardized extinction coefficients E₃₆₆₀/E₁₈₇₀ and E₃₅₀₀/E₁₈₇₀ differ markedly from the prior art.

In one particular embodiment, the composition exhibits a loss of from 1.0 to 2.5% by weight, based on the composition, on drying at 105° C. for 2 h and a loss of from 3.5 to 6.0% by weight, based on the material obtained after drying, on ignition at 1000° C. for 2 h. The loss on drying here is determined in accordance with DIN EN ISO 787/2 and the loss on ignition is determined here in accordance with DIN EN ISO 3262-20.

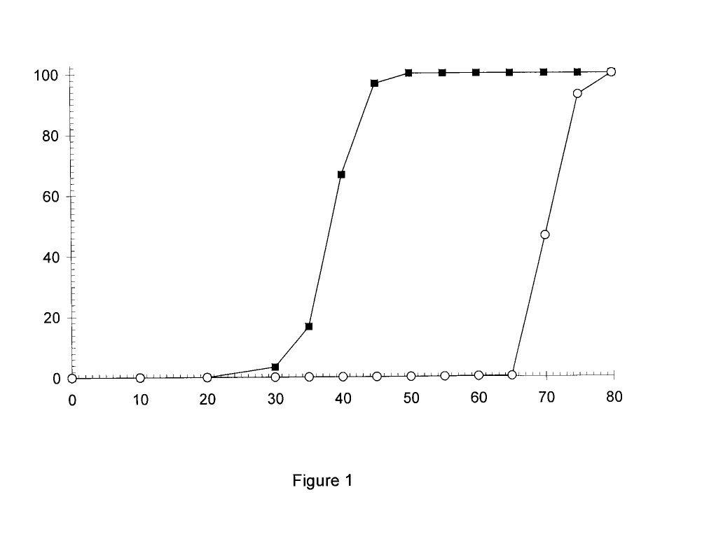

In another embodiment of the invention, the methanol wettability of the composition is less than 60%, preferably from 25% to 50%. The methanol wettability of the composition according to the invention is by way of example lower than that of the product obtained when the reaction of the same hydrophilic silica and of the same α,ω-hydroxy-terminated oligodimethylsiloxane is instead carried out at temperatures of about 200° C. Methanol wettability is determined in each case by weighing 0.2 g (±0.005 g) of silicon dioxide powder into transparent centrifuge tubes. To each weighed amount, 8.0 ml of a methanol/water mixture with respectively 10, 20, 30, 40, 50, 60, 70 and 80% by volume of methanol are added. The sealed tubes are shaken for 30 seconds and then centrifuged at 2500 min⁻¹ for 5 minutes. The sediment volumes are read off, converted into percent, and plotted against methanol content (% by volume) to give a graph. The inflection point of the curve corresponds to the methanol wettability. FIG. 1 shows a typical curve for a composition according to the invention, characterized as square, in comparison with a polydimethylsiloxane-hydrophobized silica, namely AEROSIL® R202, Evonik Industries, characterized as circle. The x-axis here is methanol content in % by volume, and the y-axis is sediment volume in %.

The invention further provides a silicone rubber which comprises the composition according to the invention and at least one organopolysiloxane. The organopolysiloxane preferably involves compounds of the general formula

AₘSiR₃₋ₘ—O—[SiR₂O]ₙ—SiR₃₋ₘ—Aₘ, where

R=alkyl, alkoxy, aryl, oxime, acetoxy, alkenyl moieties in each case having from 1 to 50 carbon atoms, unsubstituted or with substitution by O, S, F, Cl, Br, I,

A=H, OH, Cl, Br, alkenyl, acetoxy, amino, aminoxy, oxime, alkoxy, amido, alkenyloxy, acryloxy, or phosphate moieties, where the organic moieties can bear up to 20 carbon atoms, respectively identical or different.

m=0, 1, 2, 3; n=100−15 000.

Organopolysiloxanes that can be used with preference are those of the formula

H—Si(CH₃)₂O—[(CH₃)₂Si—O]ₙ—Si(CH₃)₂—H), HO—Si(CH₃)₂O—[(CH₃)₂Si—O]ₙ—Si(CH₃)₂—OH), Si(CH₃)₃O—[(CH₃)₂Si—O]ₙ—Si(CH₃)₃ or (CH₂═CH)—Si(CH₃)₂O—[(CH₃)₂Si—O]ₙ—Si(CH₃)₂—(CH═CH₂).

The viscosity of the organopolysiloxanes used according to the invention is preferably from 10⁵ to 5×10⁷ mPas at 20° C., particularly from 10⁶ to 10⁷ mPas at 20° C.

By way of example, mention may be made of Rhodorsil® Gomme 751, Bluestar Silicones, CAS No. 68083-18-1.

It is preferable that the proportion of preparation according to the invention in the silicone rubber is from 0.5 to 60% by weight, particularly from 3% to 40% by weight, very particularly from 10 to 30% by weight.

The silicone rubber according to the invention can moreover comprise the materials known to the person skilled in the art, such as crosslinking agents, crosslinking catalysts, powdered quartz, kaolin, phyllosilicates, clay minerals, diatomaceous earth, zirconium silicate and calcium carbonate, hydrophilic silica, polyvinyl chloride powder, organopolysiloxane resins, glass fibres and organic pigments, soluble dyes, fragrances, corrosion inhibitors, fungicides, bactericides or plasticizers.

The invention further provides a process for producing a silicone rubber comprising the steps of

1) producing a composition which comprises at least one surface-modified silica, in that
a) a hydrophilic silica with a BET surface area of from 150 to 400 m²/g, preferably from 180 to 350 m²/g,
b) is first brought into contact with from 5 to 40 parts by weight, preferably from 10 to 20 parts by weight, per 100 parts by weight of hydrophilic silica, of an α,ω-hydroxy-terminated oligodimethylsiloxane with an average molar mass of from 200 to 800 g/mol, preferably from 300 to 500 g/mol,
c) where the contact takes place at temperatures of from −10° C. to 50° C., and
d) then allowing the reaction mixture to stand for at least 3 days, preferably from 1 week to 1 year, at temperatures of from -10° C. to 50° C.,

2) mixing the composition at from 15 to 25° C. with an organopolysiloxane.

For step 1, the preferred embodiments in relation to the manner in which contact takes place, atmosphere, origin and BET surface area of the hydrophilic silica and dynamic viscosity of the α,ω-hydroxy-terminated oligodimethylsiloxane are intended to be the same as those mentioned for the production of the composition according to the invention. Step 2 is carried out with mixing assemblies known to the person skilled in the art.

### EXAMPLES

### Starting Materials

Hydrophilic silica used comprises a fumed silica with BET surface area 255 m²/g.

α,ω-Hydroxy-terminated oligodimethylsiloxane 1: 203D polydimethylsiloxanediol (viscosity

30 mm²/s, average molar mass from 300 to 500 g/mol).

α,ω-Hydroxy-terminated oligodimethylsiloxane 2: 203 polydimethylsiloxanediol; (viscosity

30 mm²/s, average molar mass from 300 to 400 g/mol).

### Example 1

15 parts by weight of α,ω-hydroxy-terminated oligodimethylsiloxane 1 are atomized at 20° C. in a nitrogen atmosphere into a stream of material comprising 100 parts by weight of hydrophilic silica. The mixture is fluidized at 20° C. and then stored in the presence of air for 1 week at this temperature.

The resultant composition has the following properties:

BET surface area 160 m²/g, C content 4.4% by weight, methanol wettability 10%, loss on drying 1.1% by weight and loss on ignition 4.0% by weight.

### Example 2

Analogous to Example 1, but the material is stored for a period of 4 weeks.

The resultant composition has the following properties: BET surface area 160 m²/g, C content 4.2% by weight, methanol wettability 48%, loss on drying 0.9% by weight and loss on ignition 4.0% by weight.

### Example 3

Analogous to Example 1, but α,ω-hydroxy-terminated oligodimethylsiloxane 2 is used instead of 1, and the material is stored for a period of 15 weeks.

### Example 4

Analogous to Example 3, but the material is stored for a period of 26 months.

### Example 5

Analogous to Example 1, but the material is stored for a period of 8 months.

### Example 6 (Comparative Example)

375 g/h of α,ω-hydroxy-terminated oligodimethylsiloxane 1 are atomized in liquid form at 20° C. in a nitrogen atmosphere into a stream of 2500 g/h of silica. The mixture is fluidized at 20° C. over a period of 0.25 hour by means of agitation, and then treated in a stream of air at 270° C. for 3 hours.

The resultant product has the following properties:

BET surface area 131 m²/g, C content 4.2% by weight, methanol wettability 65%, loss on drying 0.2% by weight and loss on ignition 2.5% by weight.

### Example 7 (Comparative Example)

AEROSIL® R202, Evonik Industries is used as Comparative

Example. This product is obtained through reaction of AEROSIL® 200, Evonik Industries with a polydimethylsiloxane. It has the following specification: BET surface area 100 ±20 m²/g, C content from 3.5 to 5% by weight, and loss on drying <0.5% by weight. The methanol wettability determined on a sample was 70%.

TABLE 1
Spectroscopic data

| Example | 1 | 2 | 3 | 4 | 5 | 6^{a)} | 7^{a)} |
|---|---|---|---|---|---|---|---|
| D/Q (HPDEC ²⁹Si | 34:66 | 33:67 | 26:74 | n.d. | n.d. | 46:54 | 54:46 |
| NMR) | | | | | | | |
| E₃₆₆₀/E₁₈₇₀ (IR) | 1.53 | 1.69 | 1.57 | 1.57 | 1.88 | 0.90 | 0.91 |
| E₃₅₀₀/E₁₈₇₀ (IR) | 2.80 | 2.92 | 2.71 | 2.50 | 3.25 | 0.60 | 0.63 |

### a) Comparative Example

In contrast to WO2009/077437, the composition according to the invention has no T groups.

In comparison with Comparative Examples 6 and 7, the proportions of the D groups are lower, and those of the Q groups are higher, in the compositions according to the invention.

The ²⁹Si NMR spectra of the preparations according to the invention generally reveal significant proportions of from 15 to 25 area %, based on the entirety of D3 and D4 groups. The hydrophobized silicas of Examples 6 and 7 reveal no D3 groups.

The IR spectra of the compositions according to the invention of Examples 1 to 5 also exhibit marked differences from Comparative Examples 6 and 7.

Time for incorporation into uncrosslinked silicone rubber: 100 parts of Rhodorsil® Gomme 751, Bluestar Silicones, CAS No. 68083-18-1 and 40 parts of the composition from Example 1 are mixed in a LUK-2,5 laboratory kneader from Werner and Pfleiderer at room temperature, which is from 20 to 25° C. The composition is added in three portions here, namely amounting to 60% by weight, 25% by weight and 15% by weight of the total amount, and the next addition takes place when the composition appears visually to have been absorbed within the uncrosslinked silicone rubber.

An analogous procedure is used with the compositions of Examples 3 and 7. Table 2 gives the times for incorporation. It is apparent here that, in comparison with the composition of Example 8, not according to the invention, the time for incorporation can be markedly reduced by using the compositions according to the invention from Examples 1 and 3.

TABLE 2
Times for incorporation

| Composition from Example | Time for incorporation [min] |
|---|---|
| 1 | 47 |
| 3 | 39 |
| 7 | 77 |

The reduced time for incorporation does not have any adverse effect on the mechanical and optical properties of the crosslinked silicone rubbers.

1. A process for producing a composition comprising at least one surface-modified silica, wherein
a) a hydrophilic silica
b) is first brought into contact with from 5 to 40 parts by weight per 100 parts by weight of hydrophilic silica of an α,ω-hydroxy-terminated oligodimethylsiloxane with an average molar mass of from 166 to 800 g/mol, where the contact takes place at temperatures of from −10° C. to 50° C., and
c) then allowing the resultant reaction mixture to stand for at least 3 days at temperatures of from −10° C. to 50° C.

2. The process according to claim 1, wherein the contact takes place under an inert gas atmosphere.

3. The process according to claim 1, wherein the atmosphere in which the reaction mixture is allowed to stand for at least 3 days is an oxygen-containing atmosphere.

4. The process according to claim 1, wherein the hydrophilic silica is a fumed silica.

5. The process according to claim 1, wherein the BET surface area of the hydrophilic silica is from 150 to 400 m²/g.

6. The process according to claim 1, wherein the dynamic viscosity of the α,ω-hydroxy-terminated polydimethylsiloxane is less than 50 mPas at 20° C.

7. A composition obtainable by the process according to claim 1.

8. A composition which comprises surface-modified silica and which
a) according to TEM has a structure in the form of aggregated primary particles with a BET surface area of from 150 to 250 m²/g,
b) has from 91.5 to 96.0% by weight content of SiO₂ and from 2.5 to 4.0% by weight content of C,
c) has a D/Q ratio of from 25:75 to 40:60 in the HPDEC ²⁹Si NMR spectrum, where D is the area of the signals of the D group at from −90 to −120 ppm and Q is the area of the signals of the Q group at from −10 to −30 ppm,
d) has a E₃₆₆₀/E₁₈₇₀ quotient ≧1.3 in the IR spectrum, where the E₃₅₀₀/E₁₈₇₀ quotient is 2.0, where E₃₆₆₀ is the extinction coefficient of the vibration band at 3660 cm⁻¹, E₃₅₀₀ is the extinction coefficient of the vibration band at 3500 cm⁻¹ and E₁₈₇₀ is the extinction coefficient of the vibration band at 1870 cm⁻¹.

9. The composition according to claim 8, wherein it exhibits a loss of from 1.0 to 2.5% by weight, based on the composition, on drying at 105° C. for 2 h and a loss of from 3.5 to 6.0% by weight, based on the material obtained after drying, on ignition at 1000° C. for 2 h.

10. The composition according to claim 8,
wherein its methanol wettability is less than 60%.

11. Silicone rubber comprising the composition according to claim 7 and at least one organopolysiloxane.

12. A process for producing a silicone rubber comprising:
1) producing a composition which comprises at least one surface-modified silica, wherein
a) a hydrophilic silica with a BET surface area of from 150 to 400 m²/g,
b) is first brought into contact with from 5 to 40 parts by weight, of hydrophilic silicaof an α,ω-hydroxy-terminated oligodimethylsiloxane with an average molar mass of from 200 to 800 g/mol,
c) where the contact takes place at temperatures of from −10° C. to 50° C., and
d) then allowing the reaction mixture to stand for at least 3 days at temperatures of ranging from −10° C. to 50° C.,
2) mixing the composition at from 15 to 25° C. with a preparation comprising a silicone rubber.

13. The process of claim 12, wherein in a) the hydrophilic silica has a BET surface area ranging from 180 to 350 m²/g.

14. The process of claim 12, wherein b) comprises mixing with 10 to 20 parts by weight of the hydrophilic silica.

15. The process of claim 12, wherein b) comprises mixing with the hydrophilic silica of an α,ω-hydroxy-terminated oligodimethylsiloxane with an average molar mass of from 300 to 500 g/mol.

15. The process of claim 12, wherein 2) comprises mixing the composition with a preparation comprising an organopolysiloxiane.
